(19) United States
(12) Patent Application Publication
(10) Pub. No.: US 2025/0377795 A1
(43) Pub. Date: Dec. 11, 2025

(54) LOW OVERHEAD DATA TRANSFER TO MEMORY SUBSYSTEM

(71) Applicant: Micron Technology, Inc., Boise, ID (US)

(72) Inventors: Hui Wang, Shanghai (CN); Minjian Wu, Shanghai (CN)

(21) Appl. No.: 19/226,036

(22) Filed: Jun. 2, 2025

Related U.S. Application Data
(60) Provisional application No. 63/657,732, filed on Jun. 7, 2024.

(51) Int. Cl. G06F 3/06

(52) U.S. Cl. CPC G06F 3/0611; G06F 3/0631; G06F 3/0656; G06F 3/0685

(57) ABSTRACT

A method and system for transferring data from a data capture device to a memory subsystem where the data is temporarily stored in a Host Memory Buffer (HMB) of a host system. The memory subsystem receives an indication from the host system that the HMB has been allocated in the host system. Responsive to the indication, the memory subsystem accesses a data structure in the HMB to determine a starting position of the data to be transferred. The memory subsystem transfers the data to the memory subsystem, and updates the starting position to reflect that the data has been transferred.

### CROSS-REFERENCE TO RELATED APPLICATION

The present application claims the benefit of U.S. Provisional Patent Application No 63/657,732 filed on June 7, 2024, which is incorporated by reference herein in its entirety

### TECHNICAL FIELD

The present disclosure generally relates to a memory subsystem, and more specifically, relates to low overhead data transfer to a memory subsystem memory.

### BACKGROUND ART

A memory subsystem can include one or more memory devices that store data. The memory devices can be, for example, non-volatile memory devices and volatile memory devices. In general, a host system can utilize a memory subsystem to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory subsystem in accordance with some embodiments of the present disclosure.

FIG. 2 is a block diagram illustrating the transfer of data between the data capture device, host memory buffer, and memory subsystem.

FIG. 3 is a flow diagram of an example method to transfer data captured by a data capture device to a memory subsystem in accordance with some embodiments of the present disclosure.

FIG. 4 is a flow diagram of another example method to transfer data captured by a data capture device to a memory subsystem in accordance with some embodiments of the present disclosure.

FIG. 5 is a block diagram of an example computer system in which embodiments of the present disclosure may operate.

### DETAILED DESCRIPTION

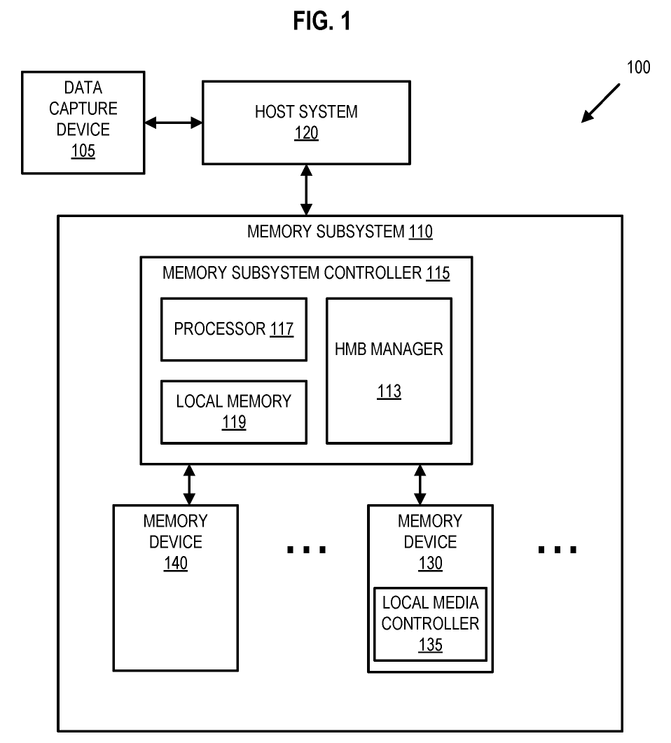

Aspects of the present disclosure are directed to a low overhead data transfer in a memory subsystem. A memory subsystem can be a storage device, a memory module, or a hybrid of a storage device and memory module. Examples of storage devices and memory modules are described below in conjunction with FIG. 1. In general, a host system can utilize a memory subsystem that includes one or more components, such as memory devices that store data. The host system can provide data to be stored at the memory subsystem and can request data to be retrieved from the memory subsystem.

A memory device can be a non-volatile memory device. A non-volatile memory device is a package of one or more dies. One example of non-volatile memory devices is a negative-and (NAND) memory device. Other examples of non-volatile memory devices are described below in conjunction with FIG. 1 . The die in the packages can be assigned to one or more channels for communicating with a memory subsystem controller. Each die can consist of one or more planes. Planes can be grouped into logic units (LUN). For some types of non-volatile memory devices (e.g., NAND memory devices), each plane consists of a set of physical blocks, which are groups of memory cells to store data. A cell is an electronic circuit that stores information.

Depending on the cell type, a cell can store one or more bits of binary information, and has various logic states that correlate to the number of bits being stored. The logic states can be represented by binary values, such as "0" and "1", or combinations of such values. There are various types of cells, such as single-level cells (SLCs), multi-level cells (MLCs), triple-level cells (TLCs), quad-level cells (QLCs), and penta-level cells (PLCs). For example, an SLC can store one bit of information and has two logic states while a QLC can store sixteen bits of information and has sixteen logic states.

Automotive and other transportation systems generate and store data from one or more subsystems. For example, a conventional video recording system used in an automobile (e.g. a dashcam, backup camera, etc.) includes a host system coupled to both a camera and a memory subsystem. As video data is captured by the camera, the camera’s device driver temporarily stores video data in the host system’s random access memory (RAM). Video recording software or firmware running on the host system (host software) then transfers the data from the host system’s RAM to non-volatile memory of the memory subsystem via multiple read/write operations. For example, transferring the video data to the memory subsystem can include the host software reading a block of video data from a first host RAM buffer allocated to the camera, optionally compressing or otherwise processing the data, writing the video data to another host RAM buffer allocated to the memory subsystem, and repeating the above operations for each block of data to be transferred. Each read/write operation involves a sequence of commands that are executed at different layers of the host system’s kernel stack, e.g. file system, block layer, device driver, etc. Data storage latency is increased by each of the multiple kernel-level commands. Data storage latency can be especially problematic for use cases that require real-time or near real-time data storage, such as an automotive “black box” data recorder.

Aspects of the present disclosure address the above and other deficiencies by using a Host Memory Buffer (HMB) allocated in the host system’s RAM for transferring video data between the camera and memory subsystem. A data structure for caching video data is allocated within the HMB. As the camera captures video, the camera’s device driver writes data directly to the data structure. The memory subsystem accesses the data structure, reads data, and writes the block to non-volatile memory. For example, the data structure may include a head pointer that indicates the next buffer portion to write to, and a tail pointer that indicates the next buffer portion to read from. The head and tail pointers may be updated by the camera’s device driver and memory subsystem, respectively, to coordinate the sequential transfer of data from the camera to non-volatile memory without, or with reduced, host software intervention. Additionally, data storage latency is reduced as host software read/write operations are reduced or eliminated. The data transfer described above is “low overhead” due to the reduction or even elimination of software overhead to perform the data transfer.

FIG. 1 illustrates an example computing system 100 that includes a memory subsystem 110, a data capture device 105, and a host system 120 coupled to both the memory subsystem 110 and data capture device 105 in accordance with some embodiments of the present disclosure. The data capture device 105 can be a video recording device, such as a video camera, or any other device for capturing streams of data (e.g. audio capture device, sensor device, etc.).

The memory subsystem 110 can include media, such as one or more volatile memory devices (e.g., memory device 140), one or more non-volatile memory devices (e.g., memory device 130), or a combination of such.

A memory subsystem 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory subsystems 110. In some embodiments, the host system 120 is coupled to different types of memory subsystems 110. FIG. 1 illustrates one example of a host system 120 coupled to one memory subsystem 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a volatile memory (e.g., DRAM), processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the memory subsystem 110, for example, to write data to the memory subsystem 110 and read data from the memory subsystem 110.

The host system 120 can be coupled to the memory subsystem 110 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), Small Computer System Interface (SCSI), a double data rate (DDR) memory bus, a dual in-line memory module (DIMM) interface (e.g., DIMM socket interface that supports Double Data Rate (DDR)), Open NAND Flash Interface (ONFI), Double Data Rate (DDR), Low Power Double Data Rate (LPDDR), or any other interface. The physical host interface can be used to transmit data between the host system 120 and the memory subsystem 110. The host system 120 can further utilize an NVM Express (NVMe) interface to access components (e.g., memory devices 130) when the memory subsystem 110 is coupled with the host system 120 by the PCIe interface. The physical host interface can provide an interface for passing control, address, data, and other signals between the memory subsystem 110 and the host system 120. FIG. 1 illustrates a memory subsystem 110 as an example. In general, the host system 120 can access multiple memory subsystems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, RAM, such as dynamic random access memory (DRAM) and synchronous dynamic random access memory (SDRAM).

Some examples of non-volatile memory devices (e.g., memory device 130) include negative-and (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Although non-volatile memory devices such as NAND type memory (e.g., 2D NAND, 3D NAND) and 3D cross-point array of non-volatile memory cells are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

A memory subsystem controller 115 (or controller 115 for simplicity) can communicate with the memory devices 130 to perform operations such as reading data, writing data, or erasing data at the memory devices 130 and other such operations (e.g., in response to commands scheduled on a command bus by controller 115). The memory subsystem controller 115 can include hardware such as one or more integrated circuits and/or discrete components, a buffer memory, or a combination thereof. The hardware can include digital circuitry with dedicated (i.e., hard-coded) logic to perform the operations described herein. The memory subsystem controller 115 can be a microcontroller, special purpose logic circuitry (e.g., a field programmable gate array (FPGA), an application specific integrated circuit (ASIC), etc.), or another suitable processor.

The memory subsystem controller 115 can include a processing device 117 (processor) configured to execute instructions stored in a local memory 119. In the illustrated example, the local memory 119 of the memory subsystem controller 115 includes an embedded memory configured to store instructions for performing various processes, operations, logic flows, and routines that control operation of the memory subsystem 110, including handling communications between the memory subsystem 110 and the host system 120.

In some embodiments, the local memory 119 can include memory registers storing memory pointers, fetched data, etc. The local memory 119 can also include read-only memory (ROM) for storing micro-code. While the example memory subsystem 110 in FIG. 1 has been illustrated as including the memory subsystem controller 115, in another embodiment of the present disclosure, a memory subsystem 110 does not include a memory subsystem controller 115, and can instead rely upon external control (e.g., provided by an external host, or by a processor or controller separate from the memory subsystem 110).

In general, the memory subsystem controller 115 can receive commands or operations from the host system 120 and can convert the commands or operations into instructions or appropriate commands to achieve the desired access to the memory devices 130 and/or the memory device 140. The memory subsystem controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices 130. The memory subsystem controller 115 can further include host interface circuitry to communicate with the host system 120 via the physical host interface. The host interface circuitry can convert the commands received from the host system into command instructions to access the memory devices 130 and/or the memory device 140 as well as convert responses associated with the memory devices 130 and/or the memory device 140 into information for the host system 120.

The memory subsystem 110 can also include additional circuitry or components that are not illustrated. In some embodiments, the memory subsystem 110 can include a cache or buffer (e.g., DRAM) and address circuitry (e.g., a row decoder and a column decoder) that can receive an address from the memory subsystem controller 115 and decode the address to access the memory devices 130.

In some embodiments, the memory devices 130 include local media controllers 135 that operate in conjunction with memory subsystem controller 115 to execute operations on one or more memory cells of the memory devices 130. An external controller (e.g., memory subsystem controller 115) can externally manage the memory device 130 (e.g., perform media management operations on the memory device 130). In some embodiments, a memory device 130 is a managed memory device, which is a raw memory device combined with a local controller (e.g., local controller 135) for media management within the same memory device package. An example of a managed memory device is a managed NAND (MNAND) device.

The memory subsystem 110 includes an HMB manager 113 that can manage the direct data transfer, using an HMB, from a host system’s volatile memory to the memory devices 130 and/or the memory device 140. In some embodiments, the controller 115 includes at least a portion of the HMB manager 113. For example, the controller 115 can include a processor 117 (processing device) configured to execute instructions stored in local memory 119 for performing the operations described herein. In some embodiments, HMB manager 113 is part of the host system 120, an application, or an operating system.

The HMB manager 113 reads data stored in the HMB and transfers the data from the HMB to the memory subsystem. Further details with regards to the operations of the HMB manager 113 are described below.

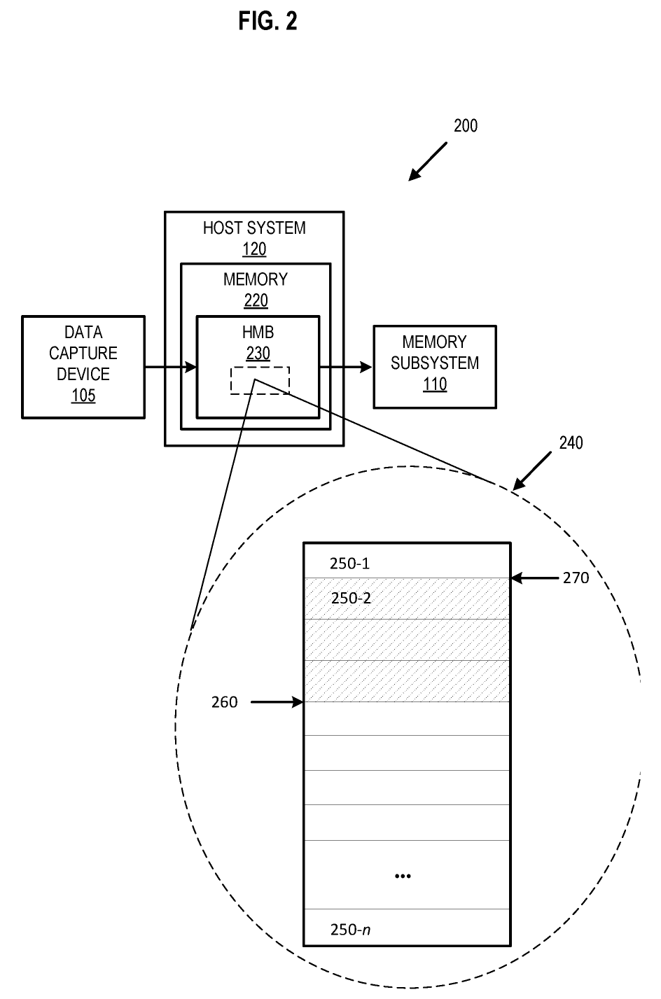

FIG. 2 is a block diagram 200 illustrating the transfer of data between data capture device 105, HMB 230, and memory subsystem 110. Host system 120 allocates an HMB 230 in the host system’s volatile memory 220. Data capture device 105 or memory subsystem 110 can specify a minimum buffer size and/or preferred buffer size of the HMB. Data capture device 105 periodically or continually captures data, and “pushes” the data (e.g. using Direct Memory Access (DMA)) to HMB 230 where the data is then “pulled” (e.g. again using DMA) by HMB manager 113 and stored in memory devices 130 of memory subsystem 110. To coordinate the “push” and “pull”, host system 120 allocates a data structure (e.g. ring buffer 240, as will be described in more detail below) in HMB 230 for accessing by data capture device 105 and by memory subsystem 110. Data capture device 105 captures data, and periodically or continually writes the captured data to the data structure in HMB 230 in the host system’s volatile memory 220. After writing the data, data capture device 105 updates the data structure to reflect that new data has been written. HMB manager 113 periodically or continually accesses the data structure and determines new data is available to be transferred to NVM. If HMB manager 113 determines that the data structure contains new data, HMB manager 113 transfers the new data from HMB 230 to memory subsystem 110’s NVM. HMB manager 113 transfers the data by reading the data from the HMB followed by writing the data to the memory subsystem’s NVM. Memory subsystem 110 then updates the data structure to reflect that the data has been transferred.

Ring buffer 240 is one example of a data structure that can be used to temporarily store data in HMB 230. Ring buffer 240 includes a plurality of addressable memory buffers 250-1-n, a head pointer 260 that points to the next available buffer to write data to (“write buffer”), and a tail pointer 270 that points to the next buffer with unread data (“read buffer). Note that the “next” buffer after 250-n is 250-1. That is, ring buffer 240 is logically circular.

A block of data to be written to ring buffer 240 is written to sequential buffers beginning with the next write buffer, following which head pointer 260 is advanced by a value equal to the number of buffers written, so that head pointer 260 is always set to the next write buffer. Data is subsequently read from ring buffer 240 beginning with data in the next read buffer and sequential buffers up to (but not including) the next write buffer, following which tail pointer 270 is advanced by a value equal to the number of buffers read. For example, HMB manager 113 can read the data in stages instead of all at once and advance the tail pointer only the number of buffers actually read, which may be less than the total number of buffers that hold unread data. Ring buffer 240 holds unread data (i.e. data was written to ring buffer 240 that is still unread) whenever tail pointer 270 and head pointer 260 are not both pointing to the same buffer. In other words, if the value of tail pointer 270 equals the value of head pointer 260, there is no new data in ring buffer 240 to read and otherwise there is new data in ring buffer 240. In FIG. 2, the buffers marked with shading indicate unread data.

While in some embodiments, the data capture device 105 both writes the data to HMB 230 and sets the head pointer to the next write buffer. In other embodiments, data capture device 105 writes the data to HMB 230 while host system software sets the head pointer to the next write buffer and notifies memory subsystem 110 that there is new data in HMB 230 to be transferred. The former approach is advantageous for latency reduction but requires data capture device 105 to support HMB in order initiate DMA data transfer and update the head pointer without host software intervention. The latter approach is advantageous since the data capture device 105 would not be required to support HMB, but may introduce some latency as this approach requires that host software initiate DMA data transfer and update the head pointer. In either case, memory subsystem 110 reads the data in HMB 230 beginning with the tail pointer, transfers the data to NVM, and updates the tail pointer to the next read buffer.

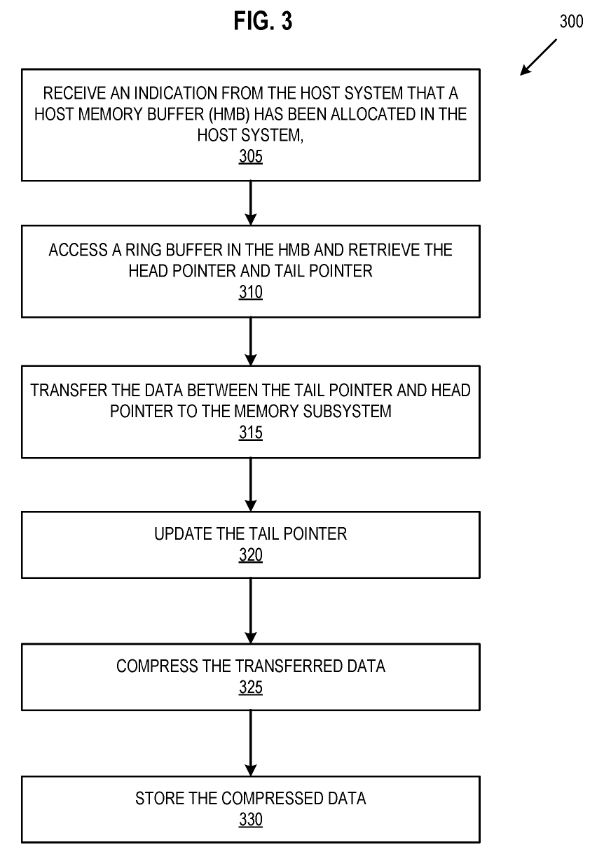

FIG. 3 is a flow diagram of an example method 300 to transfer data captured by a data capture device to a memory subsystem in accordance with some embodiments of the present disclosure. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 is performed by the HMB manager 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 305, the processing device receives an indication from the host system that an HMB has been allocated in the host system. As described previously, the HMB temporarily stores data to be transferred to the memory subsystem. Because the memory system accesses the HMB directly (i.e., the host system does not initiate memory subsystem reads of the HMB), the indication serves to notify the memory subsystem that the HMB is ready for the temporary storage and transfer of data. Also as described previously, the data to be transferred was stored in the HMB by a data capture device (e.g. a video camera) coupled to the host system. The data capture device can also receive an indication from the host system that an HMB has been allocated. The indication includes at least i) a location in memory (e.g. a memory address, etc.), and ii) a size of the HMB allocation (e.g. a number of bytes, etc.).

At operation 310, the processing device accesses a ring buffer in the HMB and retrieves the head pointer (indicative of the next write buffer), and the tail pointer (indicative of the next read buffer).

At operation 315, the processing device transfers, to the memory subsystem, the data in the ring buffer located between the tail pointer and the head pointer. That is, the processing device transfers data from, and including, the next read buffer up to but not including the next write buffer. If the tail pointer is equal to the head pointer, there is no data to transfer and the method 300 returns to operation 310 (e.g., after a delay) to continue monitoring for data.

At operation 320, the processing device updates the tail pointer to reflect that the data was transferred. As described previously, if all the data between the tail pointer and head pointer was transferred, the processing device sets the tail pointer to the head pointer. Otherwise, if less than all the data between the tail pointer and head pointer was transferred, the processing device updates the tail pointer to point to the next read buffer.

At operation 325, the processing device compresses the transferred data. For example, in the case of video data the processing device can compress the video data using a High Efficiency Video Coding (HEVC) (also known as H. 265 and MPEG-H Part 2) encoding standard.

At operation 330, the processing device stores the compressed data in the memory subsystem. For example, the processing device writes the data to non-volatile memory (e.g., memory device 130).

Operations 310 - 330 may be repeated each time data is to be transferred to the memory subsystem (e.g. by periodically retrieving the head pointer and tail pointer to determine whether the head pointer is equal to the tail pointer, and in response to determining that the head pointer and tail pointer are not equal, transferring the data between the tail pointer and head pointer).

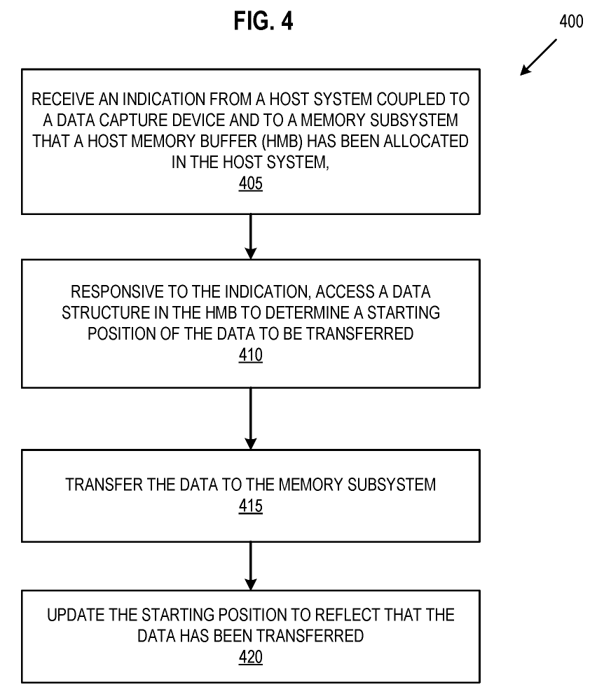

FIG. 4 is a flow diagram of another example method 400 to transfer data captured by a data capture device to a memory subsystem in accordance with some embodiments of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by the HMB manager 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 405, the processing device receives an indication from the host system that an HMB has been allocated in the host system. For example, the processing device receives an indication as described with reference to operation 305.

At operation 410, responsive to the indication, the processing device accesses a data structure in the HMB to determine a starting position of the data to be transferred. As previously described, the data structure can be a ring buffer that stores the data, a head pointer that indicates a location in the ring buffer where data is to be written, and a tail pointer that indicates a location in the ring buffer where data is to be read. The data to be transferred is the data in the ring buffer between the location indicated by the tail pointer and the location indicated by the head pointer. The processing device determines the starting position of the data to be transferred by determining the location indicated by the tail pointer as described with reference to operation 310.

At operation 415, the processing device transfers the data to the memory subsystem. As previously described, the processing device transfers the data responsive to the processing device determining that the location indicated by the tail pointer does not match the location indicated by the head pointer (i.e. the tail pointer and head pointer point to different locations within the ring buffer).

At operation 420, the processing device updates the starting position to reflect that the data has been transferred. For example, the processing device updates the tail pointer as described with reference to operation 320.

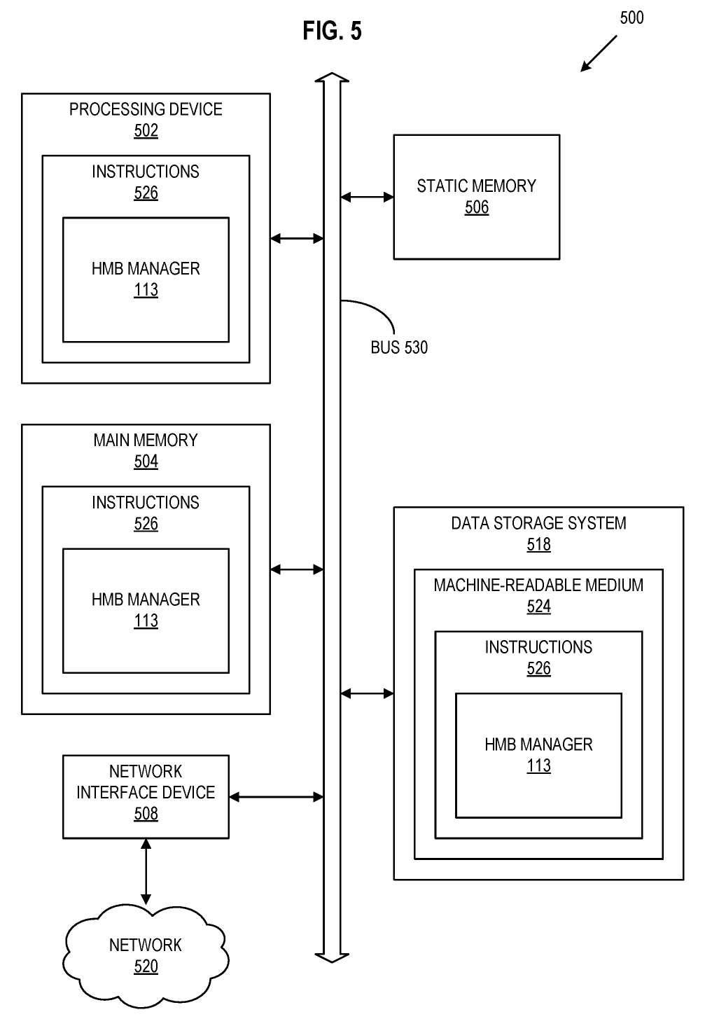

FIG. 5 illustrates an example machine of a computer system 500 within which a set of instructions, for causing the machine to perform any one or more of the methodologies discussed herein, can be executed. In some embodiments, the computer system 500 can correspond to a data capture device coupled to a host system (e.g., data capture device 105 of FIG. 1) or a host system (e.g., the host system 120 of FIG. 1) that includes, is coupled to, or utilizes a memory subsystem (e.g., the memory subsystem 110 of FIG. 1) or can be used to perform the operations of a controller (e.g., to execute an operating system to perform operations discussed herein). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a data storage system 518, which communicate with each other via a bus 530.

Processing device 502 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 502 can also be one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein. The computer system 500 can further include a network interface device 508 to communicate over the network 520.

The data storage system 518 can include a machine-readable storage medium 524 (also known as a computer-readable medium) on which is stored one or more sets of instructions 526 or software embodying any one or more of the methodologies or functions described herein. The instructions 526 can also reside, completely or at least partially, within the main memory 504 and/or within the processing device 502 during execution thereof by the computer system 500, the main memory 504 and the processing device 502 also constituting machine-readable storage media. The machine-readable storage medium 524, data storage system 518, and/or main memory 504 can correspond to the memory subsystem 110 of FIG. 1.

In one embodiment, the instructions 526 include instructions to implement functionality corresponding to an HMB manager (e.g., the HMB manager 113 of FIG. 1). While the machine-readable storage medium 524 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system, such as the controller 115, may carry out the computer-implemented methods 300 and/or 400 in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method comprising:receiving an indication from a host system coupled to a data capture device and to a memory subsystem that a Host Memory Buffer (HMB) has been allocated in the host system, wherein the HMB temporarily stores data to be transferred to the memory subsystem, and wherein the data to be transferred was stored in the HMB by the data capture device;responsive to the indication, accessing a data structure in the HMB to determine a starting position of the data to be transferred;transferring the data to the memory subsystem; andupdating the starting position to reflect that the data has been transferred.

2. The method of claim 1, further comprising:repeating the accessing, transferring, and updating for each of a plurality of data to be transferred.

3. The method of claim 1, wherein the data structure is a ring buffer that stores the data, a head pointer that indicates a location in the ring buffer where data is to be written, a tail pointer that indicates a location in the ring buffer where data is to be read, and the data to be transferred is the data in the ring buffer between the location indicated by the tail pointer and the location indicated by the head pointer.

4. The method of claim 3, wherein accessing the data structure to determine a starting position of the data to be transferred comprises:determining the location indicated by the tail pointer.

5. The method of claim 3, wherein updating the starting position to reflect that the data has been transferred comprises:updating the tail pointer to the location indicated by the head pointer.

6. The method of claim 3 wherein the transferring is responsive to determining that the location indicated by the tail pointer does not match the location indicated by the head pointer.

7. The method of claim 1, wherein the data capture device is a video camera and the data is video data captured by the video camera.

8. The method of claim 1 further comprising:compressing the transferred data.

9. A non-transitory computer-readable storage medium comprising instructions that, when executed by a processing device, cause the processing device to:receive an indication from a host system coupled to a data capture device and to a memory subsystem that a Host Memory Buffer (HMB) has been allocated in the host system, wherein the HMB temporarily stores data to be transferred to the memory subsystem, and wherein the data to be transferred was stored in the HMB by the data capture device;responsive to the indication, access a data structure in the HMB to determine a starting position of the data to be transferred;transfer the data to the memory subsystem; andupdate the starting position to reflect that the data has been transferred.

10. The non-transitory computer-readable storage medium of claim 9, further comprising instructions that, when executed by the processing device, cause the processing device to:repeat the access, transfer, and update for each of a plurality of data to be transferred.

11. The non-transitory computer-readable storage medium of claim 9, wherein the data structure is a ring buffer that stores the data, a head pointer that indicates a location in the ring buffer where data is to be written, a tail pointer that indicates a location in the ring buffer where data is to be read, and the data to be transferred is the data in the ring buffer between the location indicated by the tail pointer and the location indicated by the head pointer.

12. The non-transitory computer-readable storage medium of claim 11, wherein access the data structure to determine a starting position of the data to be transferred comprises:determine the location indicated by the tail pointer.

13. The non-transitory computer-readable storage medium of claim 11, wherein update the starting position to reflect that the data has been transferred comprises:update the tail pointer to the location indicated by the head pointer.

14. The non-transitory computer-readable storage medium of claim 11, wherein the transfer is responsive to deternining that the location indicated by the tail pointer does not match the location indicated by the head pointer.

15. The non-transitory computer-readable storage medium of claim 9, wherein the data capture device is a video camera and the data is video data captured by the video camera.

16. A system comprising:a plurality of memory devices; anda processing device, operatively coupled with the plurality of memory devices, to:receive an indication from a host system coupled to a video camera and to a memory subsystem that a Host Memory Buffer (HMB) has been allocated in the host system, wherein the HMB temporarily stores video data to be transferred to thememory subsystem, and wherein the video data to be transferred was stored in theHMB by the video camera;responsive to the indication, access a data structure in the HMB to determine a starting position of the video data to be transferred;transfer the video data to the memory subsystem; andupdate the starting position to reflect that the video data has been transferred.

17. The system of claim 16, wherein the processing device is further to:repeat the access, transfer, and update for each of a plurality of video data to be transferred.

18. The system of claim 16, wherein the data structure is a ring buffer that stores the video data, a head pointer that indicates a location in the ring buffer where video data is to be written, a tail pointer that indicates a location in the ring buffer where video data is to be read, and the video data to be transferred is the video data in the ring buffer between the location indicated by the tail pointer and the location indicated by the head pointer.

19. The system of claim 18, wherein access the data structure to determine a starting position of the video data to be transferred comprises:determine the location indicated by the tailpointer;determine the location indicated by the head pointer; anddetermine that the location indicated by the tailpointer does notmatch the location indicated by thehead pointer.

20. The system of claim 18, wherein update the starting position to reflect that the video data has been transferred comprises:update the tail pointer to the location indicated by the head pointer.
